(19) United States
(12) Patent Application Publication
(10) Pub. No.: US 2009/0083157 A1
(43) Pub. Date: Mar. 26, 2009

(54) System and method for communicating marketing information

(76) Inventors: Tom Goodman, South Padre Island, TX (US); Frank Willams, Harlingen, TX (US)

Correspondence Address: STRASBURGER & PRICE, LLP, 901 MAIN STREET, SUITE 4400, DALLAS, TX, 75202, US

(21) Appl. No.: 12/284,413

(22) Filed: Sep. 22, 2008

Related U.S. Application Data
(60) Provisional application No. 60/994,581, filed on Sep. 20, 2007.

(51) Int. Cl. G06Q 30/00; G06F 17/30

(52) U.S. Cl. 705/14; 707/104.1; 707/E17.044

(57) ABSTRACT

A system and method for communicating marketing information includes a portal by which an individual small business may enter, filter, and limit the distribution of marketing information over the internet. The information from the portal is stored in a database. Information is selected from the database and transformed to be used in one or more information display options including:
a) a newsletter of events selected by the individual small business for its selected list of recipients;
b) a detail display of information about the small business facilitating a visit by a recipient to the small business;
c) a coupon display; and
d) dynamic input to a pre-existing website of an individual small business.

### CROSS-REFERENCE TO RELATED APPLICATION

This application claims the benefit of Provisional U.S. Patent Application 60/994,581 filed Sep. 20, 2007.

### STATEMENT REGARDING FEDERALLY-FUNDED RESEARCH AND DEVELOPMENT

The invention described in this patent application was not the subject of federally-sponsored research and development.

### BACKGROUND

Individual small businesses, in the United States and in other countries, share a variety of common characteristics. For example, in an individual small business:

a) sales of both products and services, more particularly services, are made by primarily by face-to-face contact between the owners and/or the employees of the individual small business and patrons;

b) the patron base, particularly the patron base of service-oriented individual small businesses, generally includes those individuals and families that live within 10-15 miles of the individual small business, along with those patrons who may be visiting the locale in which the individual small business is located, both of which typically have an interest in the product or services offered by the individual small business;

c) there is typically no full-time person devoted exclusively to marketing in an individual small business and/or there is no full-time webmaster on staff if the individual small business has its own website;

d) the marketing budget of the individual small business is either seasonal or depends on the attainment of predetermined profit levels;

e) the commonly available marketing opportunities for conveying information to current and former patrons of the individual small business in a local area are typically top-down or broadcast communications to a large number of recipients; specifically, those commonly available marketing opportunities include print media, billboards, mass mailings, and radio/TV commercials—all of which are not directed specifically to those patrons interested in the products or services offered by the individual small business but are rather directed to a large audience which may or may not include patrons of the individual small business; and

f) the commonly available marketing opportunities for an individual small business have a built-in time delay; specifically, the commonly available marketing opportunities can take from a few days to up to several weeks before information desired to be conveyed by an individual small business is ever received by those regular, infrequent or potential patrons who would be influenced to visit the individual small business based on the content of the information.

Some individual small businesses have investigated the use of the internet as an avenue to convey marketing information. This investigation of interest use typically involves the retention of a marketing consultant who specializes in advertising or business communication over the internet. Most marketing consultants will recommend an internet communication plan including one or more of the following alternatives:

a) an internet newsletter or a series of advertisements to be sent as an e-mail blast to a large number of recipients;

b) a professionally-designed proprietary website characterized by continually changing or dynamic content;

c) on-line coupons; and

d) links to the websites of similar businesses or links to informative websites.

The anticipated benefits to the small business from the implementation of one or more of the foregoing alternatives are greater visibility of the individual small business to users of search engines such as those identified by the trademarks Google® and Yahoo!®, greater communication with the small business from website readers, and return visits to the website by those website readers interested in the offering of the individual small business.

Unfortunately, the individual small business quickly learns that to implement one or more of the foregoing alternatives, three things are required. The first requirement is either the purchase, subscription to or licensing of one or more software packages along with the cost of the design and creation of an attractive and reader-friendly proprietary website. The second requirement is the time needed to learn how to operate the one or more software packages. The third requirement is the time required to: i) keep the information in a newsletter up to date, ii) keep the information in a proprietary website current, iii) assure that the content of any coupons is directed to products or services in need of a sales incentive, and iv) assure that the links to other websites remain relevant and current and that links to new websites are added as they become available. Accordingly, many small businesses elect not to use internet based tools because of the cost and/or the time involved.

Accordingly, there continues to remain a need for a system and method for an individual small business to communicate marketing information in a timely manner over the internet; particularly, there remains a need for a utility usable by an individual small business to efficiently communicate marketing information with only to those in a community of interest shared by the individual small business, and to those regular, infrequent and potential patrons of the individual small business who will be motivated to make an in-person visit to the individual small business upon receiving marketing information from the individual small business.

### SUMMARY

The present invention provides a system and method enabling a utility for an individual small business which provides a suite of information display options for the individual small business to communicate marketing information about the individual small business over the internet. More particularly the disclosed system and method provides for communicating marketing information to a predetermined list of recipients designated by the individual small business. These recipients are regular patrons, infrequent patrons and potential patrons of the individual small business who would be motivated to make an in-person visit to the individual small business upon receiving marketing information from the individual small business.

Enabling the implementation of the present invention is a portal through which general information regarding the individual small business is easily and quickly entered by the individual small business. In addition, specific information to be sent over the internet to the predetermined list of communication recipients designated by the individual business may also be entered through the portal.

The information entered by the individual small business through use of the portal is first formatted for storage in a database and then properly formatted for use by integration into form usable by one or more information display options.

The available information display options include: a) a display of events selected by the individual small business according to a criteria established by the individual small business, b) a detailed display of information about the individual small business crafted to facilitate a visit by the reader to the individual small business, c) a coupon offering display from the individual small business or from other businesses selected by the individual small business, and d) dynamic input to a proprietary website if a website has been previously established by the individual small business.

As previously indicated, implementation software is used to select the information needed from the database to be furnished to one or more of the information display options and this selected information is then properly formatted to enable its utilization in the one or more information display options made available to the readers of the information display options—which readers are regular patrons, infrequent patrons or potential patrons who have been designated by the individual small business.

The end result from the utilization of the system and method of the disclosed invention is that an individual small business can focus the communication of important marketing information over the internet to only those interested regular, infrequent and potential patrons in its local geographic area, and to only those regular, infrequent and potential patrons in its community of interest.

### BRIEF DESCRIPTION OF THE DRAWING FIGURES

A still better understanding of the system and method for communicating marketing information may be had from a reading of the following Description of the Embodiments which refers to the following drawing figures wherein:

FIG. 1 is a macro overview of the system and method of the present invention;

FIG. 2 is a listing of the input fields in the BP portal;

FIG. 3 is a listing of storage fields in the BP database;

FIG. 4 is a chart showing the information flow to the monthly active events display option;

FIG. 5 is a screen shot of a monthly events e-mail display;

FIG. 6 is a chart showing the information flow to the coupon display option;

FIG. 7 is a chart showing the information flow to the business detail display option; and

FIG. 8 is a chart showing the information flow to the website elements display option;

### DESCRIPTION OF THE EMBODIMENTS

An initial understanding of the system and method of the present invention for communicating marketing information 10 requires a macro view of the goal to be accomplished. A more thorough understanding of the system and method of the present invention for communicating marketing information 10 may then be obtained from an explanation of the various parts of the disclosed invention and an explanation of how these parts work together to achieve the desired goal.

As indicated in the Background portion above, internet communication has not yet realized its potential as an effective marketing tool for most individual small businesses. While the reasons are many, the major reason why individual small businesses have been left out of the development of the internet as a communications tool is that the internet has become a communications tool primarily for large businesses to provide an inexpensive way to broaden their marketing communication. These large businesses desire to reach potential patrons with an unmet need or those potential patrons who make buying decisions based on an advertisement. Specifically, a Google® search typically produces a banner or word advertisement over the search results directed to a product or service related the subject matter of a search query. This is known as top-down marketing. It is hoped that the banner or word advertisement will motivate the searcher to look at the website of the large business desiring to expand the reach of their marketing communications.

Individual small businesses, particularly those individual small businesses offering services based around the actual presence of a patron at the location of the individual small business, do not have the need to expand the reach of their marketing communications. Rather, most individual small businesses need a better way to communicate in a timely manner with those regular, infrequent and potential patrons who are close enough to the individual small business to make the journey to the physical location of the individual small business when the individual small business offers something that appeals to the reader of information sent by the individual small business. This is called bottom-up marketing. Because of limited reach and small scope of bottom-up marketing, the internet has not been considered to be an effective communication tool for most individual small businesses to use for the dissemination of marketing information.

For example, when the owner of a bowling alley looks out over a number of open lanes there are very few ways that the bowling alley owner can communicate this availability to those interested in bowling. Specifically, if the bowling alley owner believes that a one-night reduction in the price of a line of bowling or a discount in the price of snack food would draw some regular patrons, infrequent patrons, or even potential patrons there is effectively no way for the bowling alley owner to communicate these one-time special offers in a timely way to either regular patrons, infrequent patrons or event potential patrons of the bowling alley.

If the bowling alley owner had the patience and the time—telephone calls could be made to regular and infrequent patrons of the bowling alley announcing the special offers. Some of these regular and infrequent patrons might call friends who have never visited the bowling alley—potential patrons—to invite them to a night of bowling.

Alternatively, if the bowling alley owner had some extra money in a marketing account, a call could be made to a local radio station to buy some time for some commercial time announcing the one-time special offers. The one-time special offers, if broadcast quickly, might be heard by a large listening audience. The large listening audience may or may not include the regular and infrequent patrons of the bowling alley.

While the internet could provide a rapid means of communication to those who have expressed an interest in bowling and those who would respond to a one-night reduction in the price of a line of bowling or discounts on food sold in the snack bar; there is no inexpensive, easy-to-use system and method for the bowling alley owner to use to enable rapid communication over the internet to a limited group of recipients.

The foregoing bowling alley example is illustrative of the need of an individual small business to be able to convey marketing information to regular, infrequent and potential patrons both in a timely manner and in a form which is likely to bring regular, infrequent or potential patrons to the physical location of the small business.

For those few small businesses fortunate enough to have a website managed by either a full-time or part-time webmaster, it may be possible to task the webmaster with a request for an e-mail blast to a predetermined list of patrons. However, even with a full-time webmaster there will be a time lag for designing the e-mail blast and then sending the e-mail blast out to the pre-determined list of regular, infrequent and potential patrons. And, as previously discussed, many small businesses simply cannot afford to have either a part-time or a full-time webmaster on staff. In addition, the small business risks losing control over message content and the list of message recipients.

With the foregoing background, the various embodiments of the system and method for communicating marketing information 10 of the present can now be better understood. In a macro sense, the system and method of the present invention provides a way for an individual small business to easily input and filter the information it desires to display to a predetermined list of information recipients or readers. Specifically, these information recipients or readers are regular patrons, infrequent patrons and potential patrons who will be motivated to visit the physical location of an individual small business once receiving marketing information from the individual small business. Accordingly, the system and method of the present invention provides an individual small business with an inexpensive, computer-based, easy-to-use marketing information dissemination management and administration utility which provide a suite of display options for marketing information. The result from use of the system and method for communicating marketing information 10 of the present invention will be visits to the physical location of the small business by regular, infrequent and potential patrons. The reason that regular, infrequent and potential patrons will visit the individual small business is that they will be provided with information about the individual small business which they would have never received but for the system and method of the present invention.

According to the preferred embodiment of the system and method of the present invention, the suite of display options for marketing information is best understood in terms of the array of display options by which a small business can convey marketing information about itself to regular, infrequent and potential patrons who will desire to act on the information and visit the individual small business.

The information display options according to the preferred embodiment of the present invention are as follows:

a) information about local events taking place in the local geographic area of the individual small business filtered by the individual small business according to an event filtering criteria established by the individual small business;

b) a changeable detailed display of information about the individual small business including selected information provided by the individual small business;

c) a display offering coupons from the individual small business and other businesses selected by the individual small business; and

d) timely input to a pre-existing website of an individual small business including information selected by the individual small business.

With the foregoing background of the results to be achieved by the disclosed system and method, it is now possible to more fully describe the system and method by which an individual small business can easily provide the needed input of marketing information to be disseminated. Using the input provided directly by the individual small business, the system and method of the present invention then uses the internet to provide the marketing information specified by the individual small business to only a selected list of regular, infrequent and potential patrons.

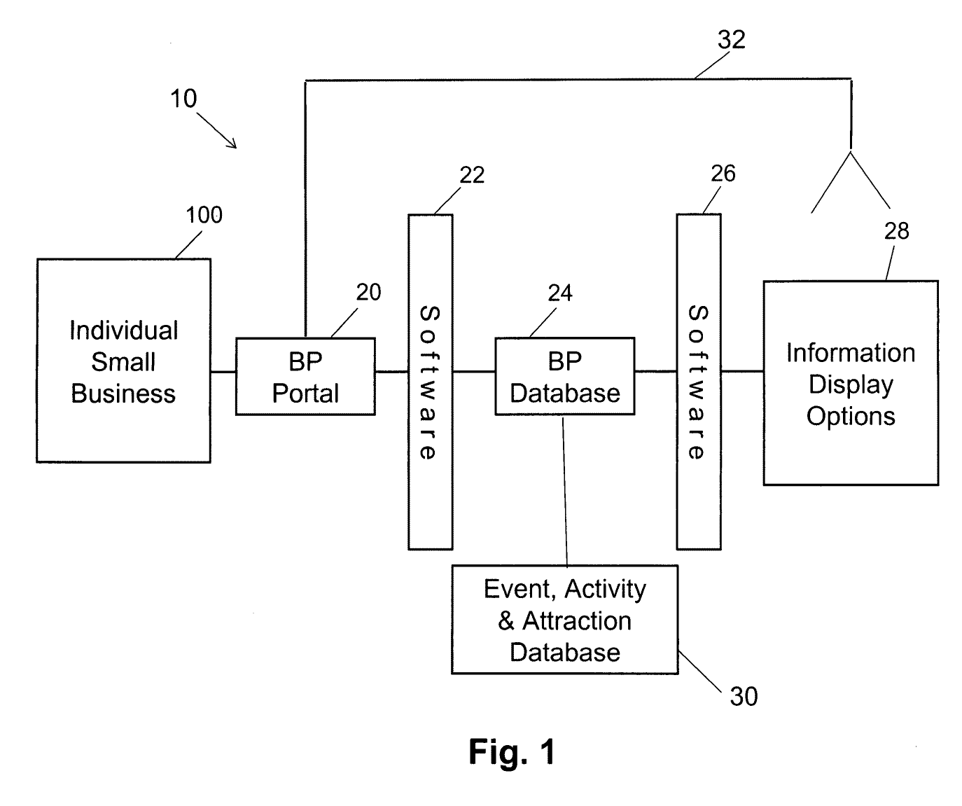

As may be seen in FIG. 1, a macro flow chart of the system and method of the present invention 10 is shown. The four information display options discussed above and termed the monthly active events e-mail, the business detail, the coupon elements, and the website elements are generically represented by the box 28 at the right side of the macro flow chart. These four information display options will be explained in greater detail below. On the left side of the flow chart is shown the BP portal 20 through which an individual small business 100 may quickly and easily enter desired information into blocks whenever they desire. The abbreviation BP, as used herein, stands for business participant. A business participant is the individual small business 100, for which the instant invention provides a heretofore unavailable communication utility.

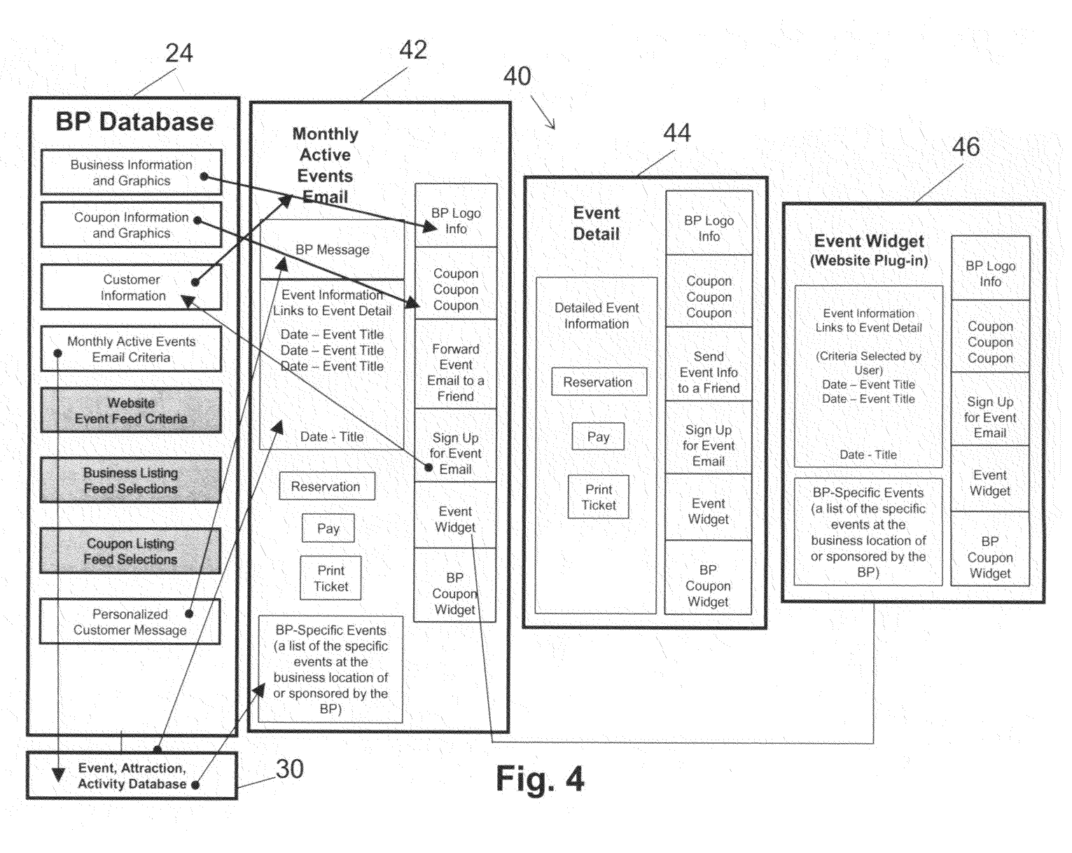

In the middle of FIG. 4 is shown the BP database 24. The BP database 24 contains information received from the BP portal 20. Further, BP database 24 is a secure database which does not permit access to or sharing of information with another small business using the system and method of the present invention. Governing the storage of information received through the BP portal 20 is a software system 22. The software system 22 assures that the input from the BP portal 20 is properly organized and stored in the BP database 24 where the needed information can then be provided to one of the information display options 28. Those of ordinary skill in the art will realize that the information display options 28 may be provided by using a variety of different prior art or proprietary software programs. Accordingly, the information contained within BP database 24 must be properly selected by software 26. Software 26 then transforms the selected information into the proper format for use by one or more prior art or proprietary software programs which use the information from BP data base 24 to provide content for the information display options 28.

The macro flow chart of the disclosed system and method in FIG. 1 also shows two optional features. The first optional feature is an event, attraction and activity database 30. The event, attraction and activity base 30 includes a listing of events from both public sources and private sources within the local area or appealing to those within a particular community of interest. Such events may include but are not limited to zoos, museums, parks, gardens, and historical sites. Information about special events offered by the individual small business is also stored in database 30. It is up to the individual small business user of the disclosed system and method 10 if the events, attractions and activities in database 30 will become part of the information provided to the regular, infrequent, and prospective patrons of the individual small business and, if so, which of these events will be listed on the monthly active events e-mail described below. For example, a small pizza restaurant may want its regular, infrequent and prospective patrons to only see a display of events in a particular city and not in surrounding cities. Alternatively, a small fitness studio may only want its regular, infrequent and prospective patrons to see a display of events regarding personal fitness.

The second optional feature is a feed back loop 32 regarding the viewing of information display options 28 to the individual small business 100. While it is expected that the individual small business 100 will experience an increased number of patrons from use of the disclosed system and method 10, the feedback loop 32 from the information display options 28 back to the BP portal 20 will allow the individual small business 100 to monitor the number of times that one or more of the information display options 28 have been viewed and adjust input into the BP portal 20 accordingly, if needed.

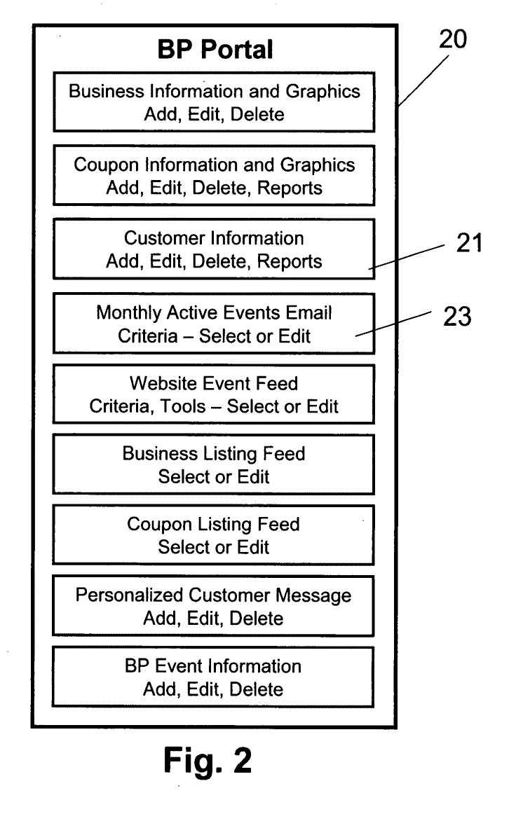

A still better understanding of the system and method of the present invention may be had by a detailed look of the data input fields provided to the individual small business in the BP portal 20. These data input fields are shown in FIG. 2. Where possible, the individual small business is provided with simple questions and along with selection buttons such as “Add”, “Edit”, and “Delete” to make use of the BP portal 20 no more difficult than sending short email messages including short phrases to a friend.

A key portion of the BP portal 20 is the information input block 21 which designates recipients. It is by use of this “Customer Information” input block 21 that the individual small business 100 designates the list of recipients to assure that desired marketing communications will go out only to those regular patrons, infrequent patrons and those prospective patrons expressing an interest in the individual small business 100. Thus, the disclosed system and method for communicating marketing information 10 is a bottom-up system whereby the recipients are those that have made themselves known to the individual small business 100 as being familiar with the individual small business—as opposed to a top-down system where an individual small business hopes to reach those that have an interest in the individual small business 100 by broadcasting their message to a large audience which may or may not include those who have an interest in the individual small business 100.

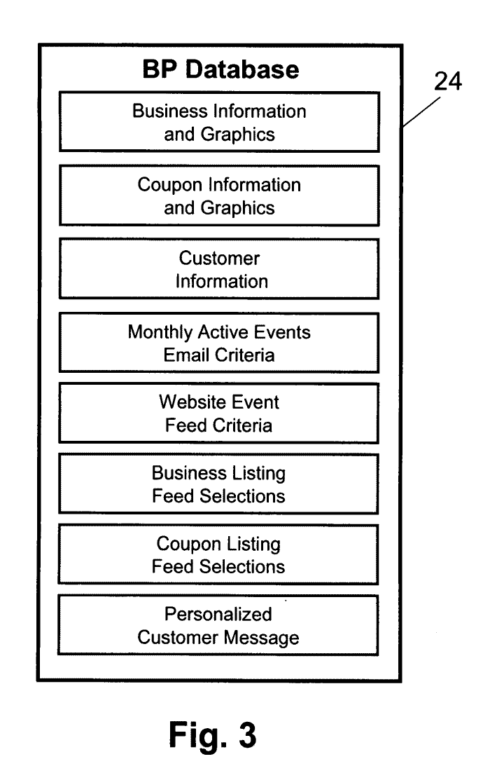

FIG. 3 is a display of the various portions of the BP database 24 in which the information provided by the individual small business through the BP portal 20 is stored. Effectively, each small business user of the system and method 10 of the present invention has its own group of storage cells in the BP database 24 from which information provided by the individual small business 100 may be sent to the various information display options 28.

Shown in FIG. 4 is the flow of information which is provided to the monthly active events information display option 40. The shaded blocks within BP database 24 contain information which is not needed for operation of the monthly active events information display option 40. The arrows indicate the information flow from the BP database 24 to various portions of the active events information display option 40.

Event information may be displayed in a monthly active events email 42, an event detail 44, or an event widget 44. The event widget 44 provides content to a portion of the pre-existing website of an individual small business. The monthly active events email 42 may use a prior art software package or proprietary software to pull information about events from database 30. The events listed in the active events email 42 are filtered for display to a reader according to the monthly active events criteria 23 selected by the individual small business in the BP portal 20. The active events email 42 is only provided to those readers designated by the individual small business in block 21 of the BP portal 20.

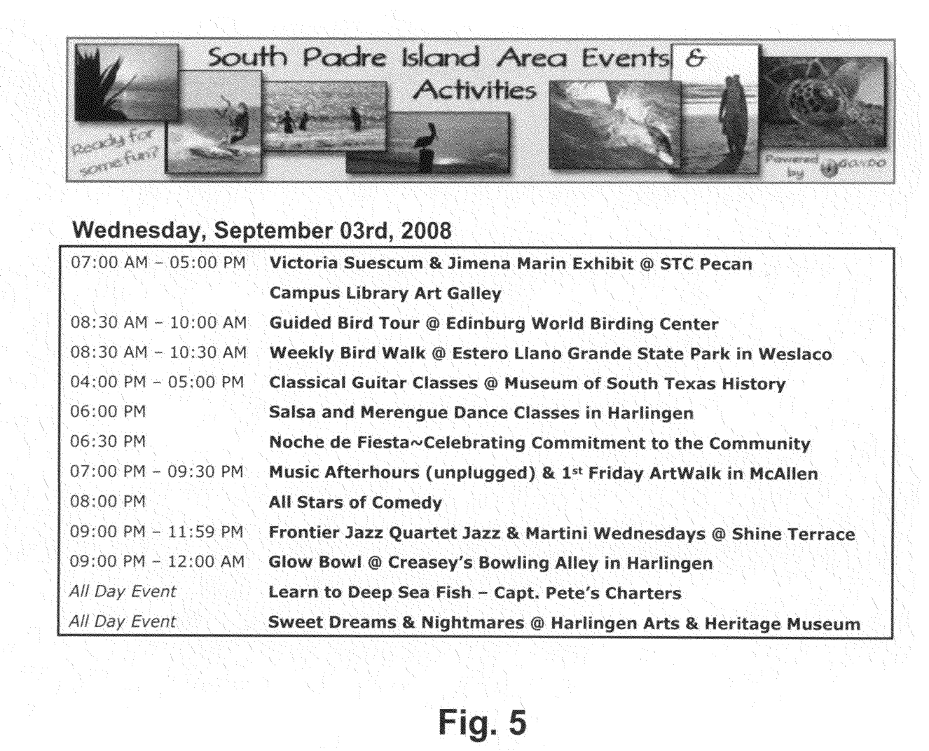

The monthly active events e-mail 42 will appear to a reader in a form similar to that shown in FIG. 5. Specifically, as shown in FIG. 4 the individual small business 100 may include a message or header. Under the message or header block will be a chronological list of events as filtered by the criteria 23 established by the individual small business 100 in the BP portal 20. If certain events are to be highlighted for the reader by the individual small business 100, a specific event may appear in a box below the chronological list of events, as shown in FIG. 4.

Along the right side of the monthly events email 42 are a column of optional boxes. The optional boxes provide a variety of functionalities for the regular, infrequent or potential patrons of the individual small business 100 to which the monthly active events email 42 is to be directed. Included in the optional boxes are such things as a logo, coupons, and the ability for the reader to send the monthly active events email 42 to a friend or to another with a similar interest. In the box labeled “Sign Up for the Events Email”, the monthly active events email 42 the reader may sign up for future editions of the monthly active events email 42.

If desired, the reader may use one or more of boxes shown to make a reservation for a selected event, pay all or a portion of the fees required to attend the selected event, and print out a ticket to the selected event. While the “Reservation”, “Pay” and “Print Ticket” boxes are shown under the list of events in the monthly active events email 42, these three boxes may appear in a variety of different locations. Such utilities are well known to those of ordinary skill in the art. The description of the operation of the event widget box and coupon widget box shown in the bottom two boxes on the right hand side of the monthly active events email 42 appear below.

A further utility is provided to the reader who wants to obtain additional information about a selected event. Specifically, the reader is able to click on a selected event in the active events email 42 and bring up an event detail screen 44. A variety of additional information will appear on the event detail screen 44 such as an event program, special aspects of the event, comments from others about the event and a map to the event. Alternatively, an ad from a source such as from the publicity for a national tour of a well-known entertainer may appear as part of the event detail 44. The same array of boxes as shown on the right-hand side of the monthly active events email 42 are also provided on the right-hand side of the event detail 44. Once again the reader is provided with the ability to sign up for future editions of the monthly event email 42 and to make a reservation for the selected event, pay for the admission to the selected event and/or print a ticket to the selected event.

Information from the BP database 24 may also be provided to a widget or a plug-in portion which fits within the pre-existing website 46 of the individual small business 100. For example, if an individual small business has a website with a list of events, the output of the BP database 24 may be directed to an event widget 46. Since the output of the BP database 24 has a filter which eliminates the display of past events, along with those events which the individual business does not want displayed, there is no need for the individual small business 100 to continually update the events portion of its own database. Rather, the system and method of the present invention provides a feed of current events selected according to the criteria 23 established by the individual small business 100. As in the monthly active events email 42 the event widget 46 provides a list of events which can be linked back to the event detail 44. As previously described, one or more coupons may be offered as shown in the second box in the right hand column of the event widget 46. The reader may also sign up for future editions of the monthly active events email 42. Links to other event widgets and coupon widgets (as described below) may also be provided by the boxes at the column on the right-hand side of the events widget 46 which plug-in to the pre-existing website of the individual small business. This direct plug-in to the pre-existing website of the small business relieves the individual small business 100 from having to continually update the events portion of a pre-existing website.

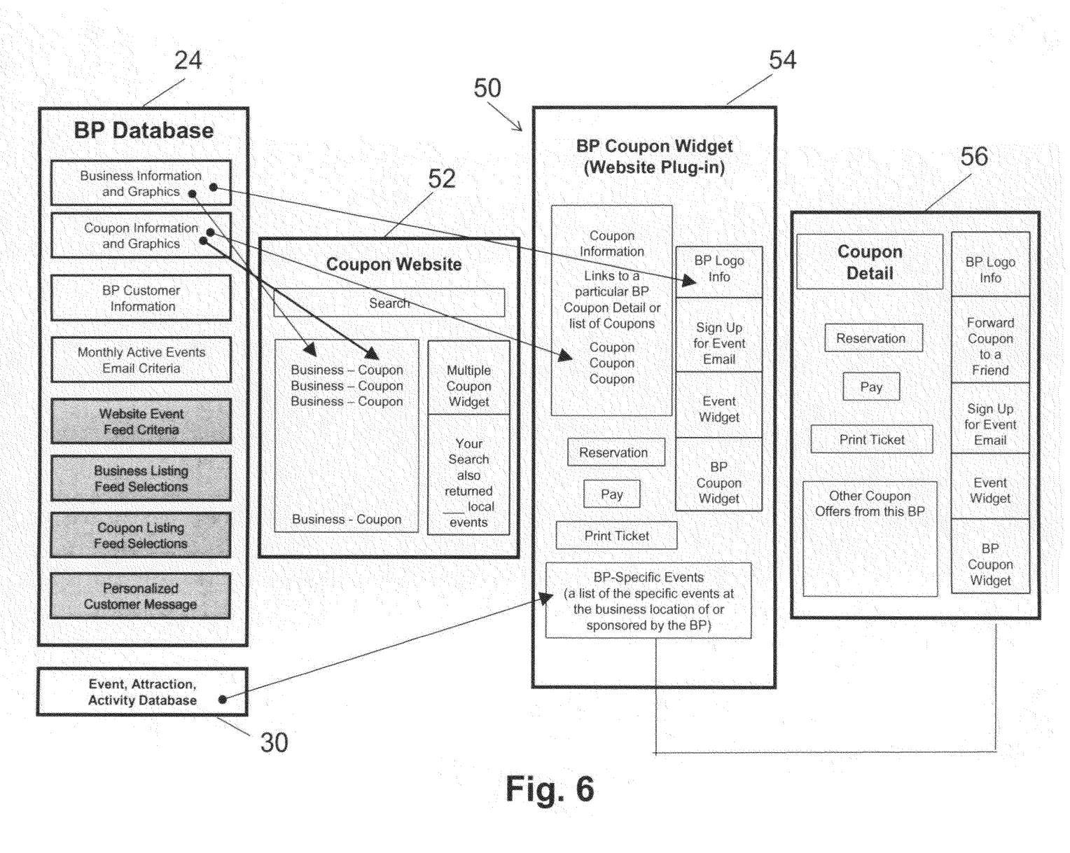

Shown in FIG. 6 is the coupon information display option 50. As indicated with respect to the description of the monthly active events information display option 40 in FIG. 4, the coupon information display option 50 is fed by information obtained from the individual small business 100 and stored in the unshaded blocks in the BP database 24.

The output of the BP database 24 is directed to a coupon website 52. The coupon website 52 includes a search feature which produces a listing of available coupons. In the right-hand column of the coupon website 52 is a box which allows the reader to move to a coupon widget 54 as described below. The coupon widget 54 is a plug-in to an existing website of the small business 100. Also included in the right-hand column of the coupon website 52 is a box which matches the search query entered to the top of the coupon website 52 to a indication of local events.

Clicking on the one of the listed coupons in the coupon website 52 leads the reader to the coupon detail 56. In the coupon detail 56 will be a reproduction of the coupon which may be in a printable form for the reader to bring to the individual small business 100. If other coupon offerings are available, the bottom box provides a link to these coupons. The boxes in the right-hand column of the coupon detail 56 were generally explained with regard to the monthly active events information display option 40 in FIG. 4 but for the second box. Instead of providing for sending event information to a friend, the second box in the right hand column of the coupon detail 56 enables sending a coupon to a friend. The third, fourth and fifth boxes in the right hand column of the coupon detail 56 provide the same utilities as in the event detail 44 in FIG. 4. Note that from the coupon detail 56, reader may also make a reservation for a selected event, pay for admission for the selected event, or print a ticket to the selected event.

The coupon website 52 may be a public website; that is, the coupon website may be made available to any reader. The reader will be able to select a category of coupons, a city, a zip code, or an exact address, or a distance from a city, a zip code or an exact address to search for available coupons. Additionally, the coupon website 52 also enables searching for a particular business by name.

The BP coupon widget 54 provides a plug-in or feed to a space in an existing website of an individual small business 100. Specifically, the information fed to the existing small business includes coupon information. The coupon information is either a listing of coupons or actual coupons. If the coupons are listed, the reader may click on a listing entry to pull up the actual coupon as shown in the coupon detail 56.

Beneath the coupon information is a box showing specific events provided by the individual small business 100 to include both events provided by the individual small business 100 events occurring near the individual small business or events of interest to the regular patrons or infrequent patrons of the individual small business.

Shown in the right hand column of the BP coupon widget 54 are a variety of different boxes to provide information to the reader. In the top position is a logo. Underneath the logo is a box permitting the reader to sign up for future editions of the monthly events e-mail 42 as described above. As previously indicated, the reader may also make a reservation for a selected event, pay for admission to the selected event and print a ticket to the selected event.

The third box in the right hand column of the BP coupon widget 54 provides a link to an event widget 46 as explained above. The fourth box in the right hand column of the coupon widget provides coupons usable at other business offered through the website of the individual small business 100 or to the websites of other small businesses with which the individual small business with which the individual small business owner may have an association.

Below the coupon offers is a box which permits the individual small business 100 to list specific events at the location of the individual small business 100, sponsored by the individual small business or of interest to the regular patrons, infrequent patrons and prospective patrons of the individual small business. Information about these events may be sent through the BP business detail 62.

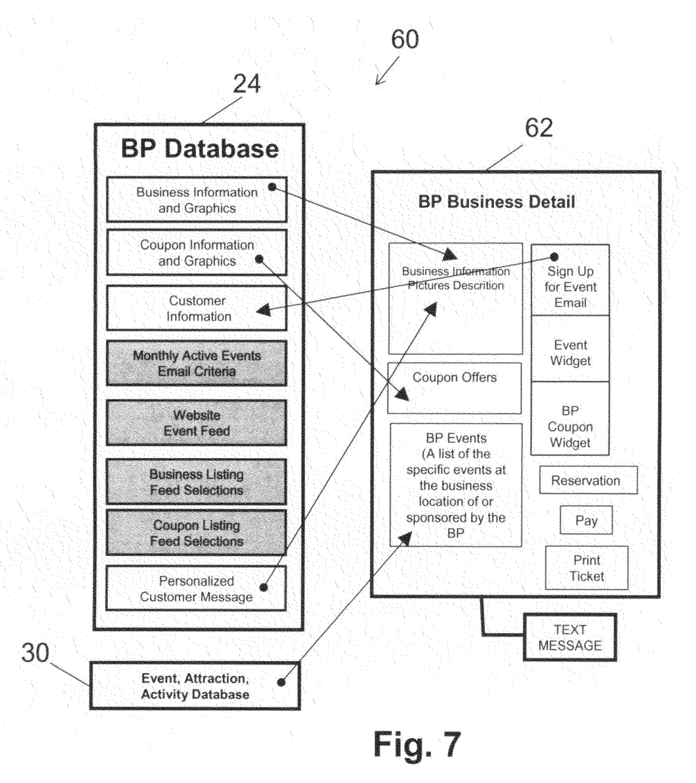

The business detail element information display option 60 is shown in FIG. 7. Herein information stored in the unshaded boxes in the BP database 24 is provided for the reader who desires to learn more about a particular individual small business 100. Shown in the BP business detail 62 are boxes leading to pictures, a description and/or a map to the individual small business 100.

If the individual small business 100 offers coupons, either listing of coupons or the actual coupons appear in a box under the business information to other devices receiving internet communication such as the text message portion of cell phones. Thus, by use of the BP events box in the business detail 62 the owner of the bowling alley, described above, would be able to provide a text message of its one night special offers through the BP business detail 62 then to the cell phones of regular patrons, infrequent patrons and prospective patrons.

In the right hand column of the BP business detail 62, the reader may sign up for future editions of the monthly event email, go to an event widget as described with respect to FIG. 4 or a coupon widget as described with respect to FIG. 6. And as previously indicated, the reader may make a reservation for a selected event, pay for admission to the selected event or print out a ticket to a selected event.

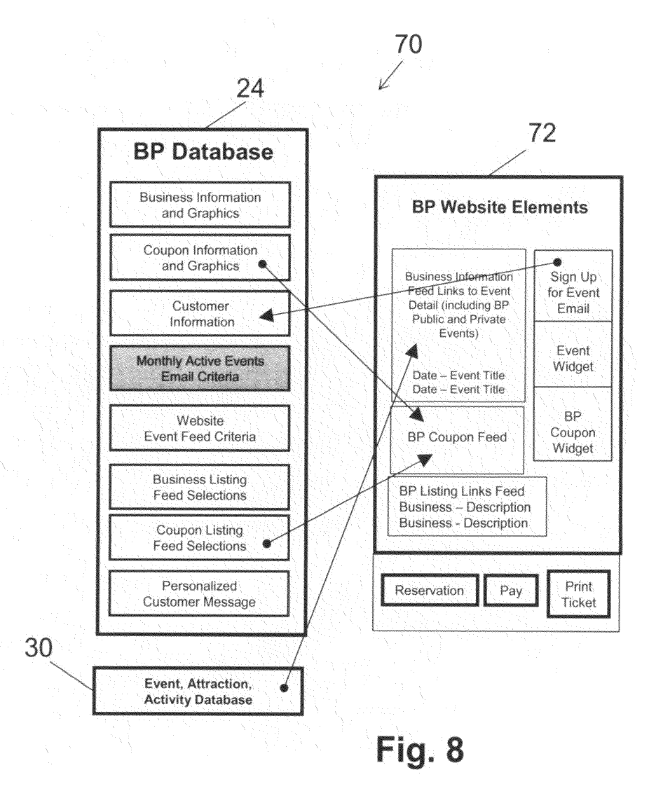

The business participant website 70 information display option shown in FIG. 8 is for the small business that already has its own website but does not have the resources needed to continually revise and update the content to be displayed to a reader. By use of the system and method of the present invention 10, information will be provided to the already existing website in a form usable by the already existing website to assure the already existing website is current and has valuable content for the reader.

As shown in FIG. 8 the information that appears in the other information display elements 40, 50, 60 is not sent to a stand-alone display element; rather it becomes a feed for the pre-existing website of the individual small business 100. Thus, the information extracted from the BP database 24 is formatted by software 26 for inclusion in a portion of the pre-existing website of the individual small business 100. Accordingly, the individual small business 100 will no longer have the problem of keeping up with events because the pre-existing website will be provided with current events selected by the individual small business 100 for its regular, infrequent and potential patrons.

The BP website element 72 may include business information as described above with respect to FIG. 7. Also included may be feed links to event details as shown in FIG. 4. Under the business information and event block may be a BP coupon feed to coupon offering of the individual small business. Below the BP coupon feed may appear links to other businesses whose offerings may be of interest to the regular, infrequent and prospective patrons of the individual small business 100.

In the right hand column of the BP website element 72, the reader may sign up for the monthly events email 42 as shown in FIG. 4, move to an event widget 46 as shown in FIG. 4 or move to a coupon widget 54 as shown in FIG. 6. And as described above, the reader may make a reservation for a selected event, pay for admission to the selected event and print a ticket to the selected event

By use of the system and method of the present invention 10 as disclosed herein, an individual small business 100 will become a subscriber to a utility for conveyance of marketing information much like an individual small business is a subscriber to the services offered by a local telephone company for the communication services needed to facilitate daily operation. The individual small business subscriber to the system and method of the present invention may either be billed a flat fee by the provider of the system and method of the present invention, by the number of times that a marketing information display option is opened for a reader to view, or a combination thereof.

Those of ordinary skill in the art will understand that the system and method for communicating marketing information of the present invention 10 provides numerous advantages for an individual small business 100. A list of these advantages appears below.

Business participants or users of the system and method of the present invention 10; particularly individual small businesses, will experience the following advantages:

the ability to tailor the marketing information dissemination of the individual small business strategy based on the perceived needs of regular, infrequent and potential patrons;

the ability to use the internet for rapid communication of a focused message or a filtered set of information items, with or without an established website, to regular patrons, infrequent patrons and potential patrons, which rapid communication of a focused message or a filtered set of information items will motivate the regular patrons, the infrequent patrons and the potential patrons to visit the individual small business;

the ability to rapidly convey a message about special offerings, sales or other unique opportunities to those who might not visit the individual small business but for knowledge of such special offerings, sales or other unique opportunities;

the ability to use the information display options to make regular patrons, infrequent patrons and potential patrons aware of other marketing information in more traditional media such as newspapers or radio/TV commercials;

the ability to provide coupons to those most likely to use the provided coupons;

the ability to use more traditional media such as billboards, newspapers or radio/TV commercials to provide regular patrons, infrequent patrons and potential patrons with notices of marketing information made available in the disclosed information display options provided by the system and method of the present invention;

the ability to use a heretofore under utilized rapid communication vehicle (the internet) to connect with regular patrons, infrequent patrons or potential patrons within a small geographic area or within a specialized community of interest market niche;

the ability to provide the reader of an information display option, set up by an individual small business, with the needed information to enable the reader to be able to decide on attending an event known by the individual small business to be of interest to the reader of the display option and then guiding the reader to the location of the event at the proper time with all the proper information and credentials needed to attend the event;

relevant marketing information is pushed out only to those regular patrons and infrequent patrons having already expressed an interest in the offerings of an individual small business at a time when the readers of the marketing information can act on the marketing information and visit the individual small business;

builds the credibility of an individual small business in the perception of regular, infrequent and prospective patrons by not diluting needed marketing information with extraneous information;

the ability to communicate with other individual small businesses whose sales depend on face-to-face contact to work together to meet the interests of regular patrons, infrequent patrons and potential patrons;

the ability to enable government agencies, schools, and non-profit groups to communicate their offerings, specifically to those having an interest in the work or activities of the government agencies, schools and non-profit groups;

the ability to enable regular patrons and infrequent patrons to spread information about an individual small business to potential patrons heretofore unknown to the individual small business to motivate these potential patrons to visit the location of the individual small business;

the ability of an individual small business to establish a connection with an upcoming event without having to become a sponsor of the upcoming event;

the ability of an individual small business to dynamically change its message, its image or its offerings to both regular and infrequent patrons without having to undertake a large market re-education program.

Still other advantages of the disclosed system and method for communicating marketing information will become apparent to those of ordinary skill in the art upon an understanding of the preferred and alternate embodiments described above. Further, those of ordinary skill in the art will understand that modifications may be made to the disclosed invention to expand its utility into other areas. Such modifications shall fall within the scope and meaning of the appended claims.

What is claimed is:

1. A system for providing a suite of marketing information display options to an individual business for communicating information about the individual business over the internet to a predetermined list of communication recipients designated by the individual business, said system comprising:
a portal for inputting information about the individual business and the types of information to be sent over the internet to the predetermined list of communication recipients designated by the individual business;
a database for storing the information about the individual business input through said portal;
software means for formatting said information input into said portal for storage as a record for the individual business within said database;
one or more display options for said information about the individual business to be communicated to the predetermined list of recipients designated by the individual business;
software means for selecting those portions of said information contained in said database designated by said individual business and formatting said selected information for use in said one or more display options.

2. The system as defined in claim 1 wherein said database for storing the information about the business is supplemented by at least one other database containing information about events, attractions and activities of interest to the predetermined list of communication recipients designated by the individual business.

3. The system as defined in claim 1 wherein said one or more display options are selected from a group including: a display of a list of events selected by the individual business according to a criteria established by the individual business, a detailed display of information about the individual business; a display offering coupons from the individual business; and input to the website previously established by the individual business.

4. The system as defined in claim 3 wherein said display of a list of events selected by the individual business further includes:
the date and title of each event in the list of events;
links to a display of event detail information about each event contained in said list of events;
one or more additional items selected from a list including:
a logo or trademark of the individual business;
a message to the designated recipients from the individual business;
a list of events provided by the individual business;
one or more coupons offered by the individual business or other businesses;
means to forward said display of the list of events to another recipient named by the designated recipient;
means to sign-up for future editions of said display of a list of events;
means for making a reservation to attend a selected event;
means for paying all or a portion of the admission to said selected event;
means for printing out a ticket for selected event;
a link to a coupon offering on the website of the individual business, and
a link to a more detailed description of an event on another website.

5. The system as defined in claim 4 wherein said display of event detail information includes one or more of the following:
a logo or trademark of the individual business;
one or more coupons offered by the individual business or other businesses;
means to forward the display of additional information about the events to another recipient designated by the individual recipient;
means to sign-up for future editions of said display of a list of events;
means for making a reservation to attend a selected event;
means for paying for all or a portion of the admission for said selected event;
means for printing out a ticket to said selected event;
a link to a more detailed description of an event on another website; and
a link to one or more coupons offered by the individual business or other businesses on another website.

6. The system as defined in claim 4 wherein said link to a more detailed description of an event on another website includes one or more of the following:
additional information about the event;
a listing of specific events designated by the individual business;
a logo or trademark of the individual business;
one or more coupons offered by the individual business or other businesses;
means to sign-up for future editions of said display of a list of events;
means or making reservation to attend a selected event;
means to pay for all or a portion of the admission fee for said selected event;
means for printing out a ticket to gain admission to said selected event;
a link to another description of the event on another website; and
a link to a coupon on another website.

7. The system as defined in claim 3 wherein said detail display of information about the individual business further includes:
graphic or written description of the individual business provided by the individual business and one or more of the following;
one or more coupons offered by the individual business or other businesses;
a listing of selected events provided by the individual business;
means to sign-up for future editions of said display of a list of events;
means for making a reservation to attend a selected event;
means for paying for all or a portion of the admission for said selected event;
means for printing out a ticket for said selected event;
a link to a more detailed description of said selected event on another website;
a link to a coupon offering on another website.

8. The system as defined in claim 7 wherein said link to a more detailed description of said selected event on another website is in the form of a text message that may be transmitted to a cellular telephone.

9. The system as defined in claim 3 wherein said display offering coupons from the individual business further includes:
means for performing a word search;
a listing of coupons offered by the individual business or other businesses related to the results of said word search;
a link to a detail display of each coupon in said listing of coupons and one of both of the following;
means for selecting a coupon from said listing of coupons offered by the individual business or other businesses to link to another website containing a detail of the coupon;
a listing of events related to the results of said word search.

10. The system as defined in claim 9 wherein link to a detail display of each coupon includes:
a printable version of the coupon offered by the individual business or other businesses; and
one or more of the following:
additional coupon offers from the individual business;
a logo or trademark of the individual business;
means to forward said printable version of the coupon to another recipient named by the designated recipient;
means to sign up for future editions of said display of a list of events;
means for making a reservation to attend a selected event;
means for paying all or a portion of the admission to said selected event;
means for printing out a ticket for said selected event;
a link to a more detailed description of said selected event on another website;
a link to a coupon offering of the individual business on another website.

11. The system as defined in claim 10 wherein said link to a coupon offering of the individual business on another website includes one or more of the following:
a listing of coupons;
a listing of specific events offered or sponsored by the individual business;
a logo or trademark of the individual business;
means to sign-up for future editions of said display of a list of events;
means for making a reservation to attend a selected event;
means for paying for all or a portion of the admission for said selected event;
means for printing out a ticket for selected event;
a link to a more detailed description of said selected event on another website;
a link to a one or more coupons offered by the individual business or other businesses on another website.

12. The system as defined in claim 3 wherein said input to the website previously established by the individual business further includes one or more of the following:
information describing the individual business;
one or more coupon offerings of the individual business;
one or more business listing links to other businesses;
means to sign-up for future editions of said display of a list of events;
means for making a reservation to attend a selected event;
means for paying all or portion of the admission fee to said selected event;
means for printing out a ticket for said selected event;
a link to a more detailed description of an event on another website;
a link to a coupon offering on the website of the individual business or on the website of another business.

13. A method for providing a suite of marketing information displays to an individual business for communicating information about the individual business over the internet to a pre-determined list of communication recipients designated by the individual business, said system comprising the steps of:
providing a portal for inputting information about the individual business and the types of information to be sent over the internet to the predetermined list of communication recipients designated by the individual business;
storing the information about the individual business input through said portal in a database;
formatting said information input into said portal to enable storage as a record for the individual business within said database;
one or more display options for said information about the individual business to the predetermined list of recipients designated by the individual business;
selecting those portions of said information contained in said database designated by said individual business; and
formatting said selected information for use in said one or more display options.

14. The method as defined in claim 13 further including the step of supplementing said database with information from said at least one other database containing information about events, attractions and activities of interest to the predetermined list of communication recipients designated by the individual business.

15. The method as defined in claim 13 wherein said one or more display options are selected from a group including: a display of a list of events selected by the individual business according to a criteria established by the individual business, a detail display of information about the individual business; a display offering coupons from the individual business; and input to the website previously established by the individual business.

16. The method as defined in claim 15 wherein said display of a list of events selected by the individual business further includes:
the date and title of each event in the list of events;
links to a display of event detail information about each event contained in said list of events;
one or more additional items selected from a list including:
a logo or trademark of the individual business,
a message to the designated recipients from the individual business,
a list of events provided by the individual business,
one or more coupons offered by the individual business or other businesses
means to forward said display of the list of events to another recipient named by the designated recipient,
means to sign-up for future editions of said display of the list of events;
means for making a reservation to attend a selected event;
means for paying all or a portion of the admission to said selected event;
means for printing out a ticket for selected event;
a link to a coupon offering on the website of the individual business, and
a link to a more detailed description of an event on another website.

17. The method as defined in claim 15 wherein said display of event detail information about an event includes one or more of the following:
a logo or trademark of the individual business;
one or more coupons offered by the individual business or other businesses;
means to forward the display of additional information about the events to another recipient designated by the individual recipient;
means to sign-up for future editions of said display of the list of events;
means for making a reservation to attend a selected event;
means for paying for all or a portion of the admission for said selected event;
means for printing out a ticket to said selected event;
a link to a more detailed description of an event on another website; and
a line to one or more coupons offered by the individual business or other businesses on another website.

18. The method as defined in claim 16 wherein said link to a more detailed description of an event on another website includes one or more of the following:
additional information about the event;
a listing of events designated by the individual business;
a logo or trademark of the individual business;
one or more coupons offered by the individual business or other businesses;
means to sign-up for future editions of said display of the list of events;
means for making a reservation to attend a selected event;
means to pay for all or a portion of the admission fee for selected event;
means for printing out a ticket to gain admission to selected event;
a link to another description of the event on another website; and
a link to a coupon on another website.

19. The method as defined in claim 15 wherein said detail display of information about the individual business further includes:
graphic or written description of the individual business provided by the individual business; and one or more of the following:
one or more coupons offered by the individual business or other businesses;
a listing of selected events provided by the individual business;
means to sign-up for future editions of said display of the list of events;
means for making a reservation to attend a selected event;
means for paying for all or a portion of the admission for said selected event;
means for printing out a ticket for said selected event;
a link to a more detailed description of said selected event on another website;
a link to a coupon offering on another website.

20. The method as defined in claim 19 wherein said link to a more detailed description of said selected event on another website is in the form of a text message that may be transmitted to a cellular telephone.

21. The method as defined in claim 15 wherein said display offering coupons from the individual business further includes:
means for performing a word search;
a listing of coupons offered by the individual business or other businesses related to the results of said word search;
a link to a detail display of each coupon in said listing of coupons, and one or more of the following:
means for selecting a coupon from said listing of coupons offered b the individual business or other businesses to link to another website containing a detail of the coupon;
a listing of events related to the results of said word search.

22. The method as defined in claim 20 wherein said link to a detail display of each coupon includes;
a printable version of the coupon offered by the individual business or other businesses;
one or more of the following:
additional coupon offers from the individual business;
a logo or trademark of the individual business;
means to forward said printable version of the coupon to another recipient named by the designated recipient;
means to sign up for future editions of said display of the list of events;
means for making a reservation to attend said selected event;
means for paying all or a portion of the admission to said selected event;
means for printing out a ticket for said selected event;
a link to a more detailed description of said selected event on another website;
a link to a coupon offering of the individual business on another website.

23. The method as defined in claim 22 wherein said link to a coupon offering of the individual business on another website includes one or more of the following:
a listing of coupons;
a listing of specific events offered or sponsored by the individual business;
a logo or trademark of the individual business;
means to sign-up for future editions of said display of the list of events;
means for making reservation to attend a selected event;
means for paying for all or a portion of the admission for said selected event;
means for printing out a ticket for selected event;
a link to a more detailed description of said selected event on another website;
a link to a one or more coupons offered by the individual business or other businesses on another website;

24. The method as defined in claim 15 wherein said input to the website previously established by the individual business further includes one or more of the following:
information describing the individual business;
one or more coupon offerings of the individual business;
one or more business listing links to other businesses;
means to sign up for future editions of said display of the list of events;
means for making a reservation to attend a selected event;
means for paying all or portion of the admission fee to said selected event;
means for printing out a ticket for said selected event;
a link to a more detailed description of an event on another website;
a link to a coupon offering on the website of the individual business or on the website of another business
